(19) United States
(12) Patent Application Publication
(10) Pub. No.: US 2007/0061322 A1
(43) Pub. Date: Mar. 15, 2007

(54) Apparatus, method, and program product for searching expressions

(75) Inventor: Kazuo Nemoto, Kawasaki-shi (JP)

Correspondence Address: Grant A. Johnson;IBM Corporation, Dept. 917, 3605 Highway 52 North, Rochester, MN, 55901-7829, US

(73) Assignee: International Business Machines Corporation, Armonk, NY (US)

(21) Appl. No.: 11/515,583

(22) Filed: Sep. 5, 2006

(30) Foreign Application Priority Data
Sep. 6, 2005 (JP) 2005-257429

(51) Int. Cl. G06F 17/30

(52) U.S. Cl. 707/5

(57) ABSTRACT

The present invention effectively extracts useful information in a field in which a user is interested, using a search apparatus for searching expressions from a plurality of texts. The search apparatus records predetermined expressions in advance included in at least one text as expressions to be evaluated for which attention degrees are evaluated. Then, a plurality of keywords is input. The search apparatus determines, for each of the keywords, use frequencies of the expressions to be evaluated in a text including that keyword. Then, attention degrees of the expressions to be evaluated are evaluated based on the respective use frequencies determined for each of the keywords.

### FIELD OF THE INVENTION

The present invention relates to a search apparatus, a search method, and a program product there for. More particularly, the present invention relates to a search apparatus, a search method, and a program product for searching expressions from a plurality of texts.

### BACKGROUND ART

In recent years, the number of fields undergoing severe changes have been increasing, like the IT (Information Technology) field. In such a field, it becomes important to effectively extract new information from an information source, such as the Internet, in order to follow the changes. In this regard, a search technique for text data, referred to as a search engine or a search site has been conventionally used. As an example, a search engine, such as Google® (“http://www.google.com/”), searches texts including an expression input by a user from the Internet and displays texts found to the user. Since this search process is extremely high speed and quite a number of texts are searched, such searches are popular at present.

Moreover, websites have been providing information, such as news, by means of data based in a predetermined format, such as RSS (Rich Site Summary), in addition to providing text data. Here, RSS is a standardized format for use in contents delivery using XML. Using RSS, a head line and a summary of news can be determined by tags or attribute values of XML. Therefore, it is possible to realize efficient search according to the demand of user by using dedicated search software.

Also, data mining for automatically extracting only useful information from a huge amount of data has been studied. Using data mining techniques, it is possible to analyze data accumulated in large amounts in a company, such as sales data of a retail store, a call history of a telephone, and a use history of a credit card, to find correlations between various items included therein.

However, the number of texts searched by a search engine is enormous in many cases. For this reason, a user must find useful information from many retrieved texts based on knowledge and experience of the user in order to obtain truly desired information. Moreover, while search efficiency is improved by standardization, such as the RSS, the amount of information to be searched is still enormous. Furthermore, information standardized by the RSS is generally information with high reliability created by a news provider. However, in order to follow a change in a specific field, information in bulletin boards and Weblogs written by general users may become useful.

In addition, a conventional search engine sorts and displays retrieved texts based on priority in order to reduce user's workload. This priority is determined by, e.g., the number of references by which each text is referred to from other texts. The number of references becomes a scale measuring a degree of interest of all web page creators. In this way, it is possible to preferentially display a text in which many people are generally interested.

However, information that a user wants to extract is not necessarily an object in which many people are already interested. Rather, a user may want to obtain information that is not yet commonly known, but will become rapidly known among many people from now on. Furthermore, a search engine searches the whole Internet as a search object, regardless of contents of texts and target fields. For this reason, there is a problem that a user may obtain undesired information from fields in which the user is not interested.

In contrast, data mining is studied with the aim of automatically extracting only useful information. More particularly, according to text mining that is an example of data mining, it is possible to increase accuracy of information extraction by specifying semantics of texts by means of context analysis. However, dictionary data for context analysis become necessary to realize text mining at a practical technical level. Conventionally, such dictionary data has been created by a developer registering necessary words manually. For this reason, a lot of cost and time have been necessary for development and maintenance thereof.

Japanese Patent 3,606,566 teaches a technique in which a level of importance of a keyword is evaluated based on a count value of the number of times the keyword appears. A level of importance of a keyword is determined based on a change of the count value according to the passage of time. In this way, the fact that the keyword has been suddenly used these days can be utilized as an evaluation criterion of a level of importance. However, this technique could not detect that a specific keyword had been rapidly used in a specific field based on mixed information in various fields.

### SUMMARY OF THE INVENTION

Embodiments of present invention include an apparatus, a method, and a program product that provide an improved search technique for the foregoing problems. Those skilled in the art will appreciate that accompanying figures and description depict and describ embodiments of the present invention, and features and components thereof. Any particular program nomenclature used in this description is merely for convenience, and thus the invention should not be limited to use solely in any specific application identified and/or implied by such nomenclature. Therefore, it is desired that the embodiments described herein be considered in all respects as illustrative, not restrictive, and that reference be made to the appended claims for determining the scope of the invention.

According to a first aspect of the present invention, there is provided a search apparatus for searching expressions from a plurality of texts, which includes a recording component recording in advance predetermined expressions included in at least one text as expressions to be evaluated for which attention degrees are evaluated, an input component inputting a plurality of keywords, a frequency determining component determining, for each of the keywords, use frequencies of the expressions to be evaluated in a text including that keyword, and an evaluating component evaluating the attention degrees of the expressions to be evaluated based on the respective use frequencies determined for each of the keywords. A search method by the search apparatus and a program for causing an information processing apparatus to function as the search apparatus are also provided.

According to a second aspect of the present invention, there is provided a search apparatus for searching expressions from a plurality of texts, which includes a dictionary recording component recording a plurality of expressions in advance, an input component inputting a plurality of keywords from a user, a detecting component detecting, for each of the keywords, unregistered expressions not recorded in the dictionary recording component among the expressions included in a text including that keyword, and a selecting component selecting and outputting, for at least two of the keywords, one or more unregistered expression that have been detected from texts including any of the at least two keywords. A search method by the search apparatus and a program for causing an information processing apparatus to function as the search apparatus are also provided.

According to a third aspect of the present invention, there is provided a search apparatus for searching expressions from a plurality of texts, which includes a recording component recording in advance predetermined expressions included in a text as expressions to be evaluated for which attention degrees are evaluated, an input component inputting a keyword, a frequency determining component determining use frequencies of the expressions to be evaluated in a text including that keyword at a plurality of different points in time, and an evaluating component evaluating the attention degree higher in the case where a rate of increase of the use frequency from the one determined for that keyword at a first point in time to the one determined for that keyword at a second point in time after the first point in time is higher, than in the case where the rate of increase is lower. A search method by the search apparatus and a program for causing an information processing apparatus to function as the search apparatus are also provided.

The above as well as additional objectives, features, and advantages of the present invention will become apparent in the following detailed description.

### BRIEF DESCRIPTION OF THE DRAWINGS

The novel features believed characteristic of the invention are set forth in the added claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a functional configuration of a search apparatus according to the present invention.

FIG. 2 shows a functional configuration of an expression selecting component in the search apparatus.

FIG. 3 shows a functional configuration of an attention degree evaluating component in the search apparatus.

FIG. 4 shows a flow of a process in which attention degrees of expressions are evaluated by the search apparatus.

FIG. 5 shows a conceptual diagram of a process in S410.

FIG. 6 shows a first part of a specific example of a process in S410.

FIG. 7 shows a second part of the specific example of the process in S410.

FIG. 8 shows details of a process in S420.

FIG. 9 is a conceptual diagram showing a process in S800.

FIG. 10 shows a specific example of a process in S910.

FIG. 11 is a conceptual diagram showing a computation method for attention degrees.

FIG. 12 shows another example of the process in S910.

FIG. 13 shows a display example of a screen displayed by a display component on a user terminal.

FIGS. 14A and 14B show details of display contents in two display areas.

FIG. 15 shows an exemplary hardware configuration of an information processing apparatus functioning as the search apparatus.

### DETAILED DESCRIPTION OF THE INVENTION

The invention will now be described with reference to a preferred embodiment, which does not intend to limit the scope of the present invention, but merely exemplifies the invention.

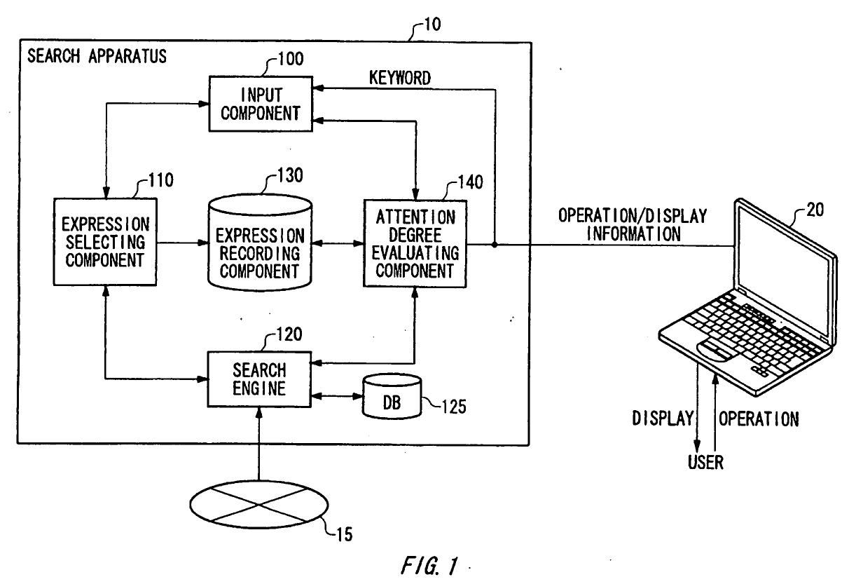

FIG. 1 shows a functional configuration of a search apparatus 10. The search apparatus 10 searches expressions from a plurality of texts opened on a network 15 based on a plurality of keywords input from a web browser or the like that operates in a user terminal 20. The search apparatus 10 outputs retrieved expressions to the user terminal 20 in association with attention degrees evaluated based on those keywords. The user terminal 20 displays the received keywords and attention degrees to a user by means of a web browser or the like. Unlike the conventional art, the attention degree is an index value showing that it is strongly associated from every keyword rather than association with only one of the keywords. The attention degree is computed further based on the difference between current and previous search results. In this way, the present invention can effectively and easily extract useful information in a field in which a user is interested.

The search apparatus 10 has an input component 100, an expression selecting component 110, a search engine 120, a database 125, an expression recording component 130, and an attention degree evaluating component 140. The input component 100 inputs a plurality of keywords from the user terminal 20. It is desirable that a keyword is a symbolic expression in a field in which a user is interested. Here, a keyword may be, in addition to a noun, an expression of another word class such as a verb or an adjective. An expression may be a single word or a phrase consisting of a plurality of words. The expression selecting component 110 selects an expression to be evaluated, for which an attention degree is evaluated, from unregistered expressions that are not registered in a dictionary based on the input keywords, and records the selected expression in the expression recording component 130. The search engine 120 may be used in order to select an expression to be evaluated.

The search engine 120 performs normal text search. Specifically, the search engine 120 has a language processing function for a morphological analysis. Thus, the search engine 120 can decompose a text into word classes to search expressions. As an example, the search engine 120 may retrieve a text including a specified keyword from the network 15. A search process is not necessarily performed after a keyword is specified. That is to say, for example, the search engine 120 may record in advance, for each of predetermined keywords, a result of search by that keyword in the database 125. At this time, when a keyword is specified, the search engine 120 may read and output the result of search by that keyword from the database 125.

The expression recording component 130 records a unregistered expression selected by the search engine 120 as an expression to be evaluated. In the case where a plurality of unregistered expressions are selected, the expression recording component 130 may record those unregistered expressions as a plurality of expressions to be evaluated. The expression recording component 130 may further record an attention degree evaluated by the attention degree evaluating component 140 in association with an expression to be evaluated. The attention degree evaluating component 140 evaluates an attention degree indicating a degree of attention given to an expression to be evaluated recorded in the expression recording component 130 in a field specified by the input keyword. The search engine 120 may be used in order to perform an evaluation process for an expression to be evaluated. The attention degree evaluating component 140 outputs the attention degree to the user terminal 20 in association with the expression to be evaluated and makes the user terminal 20 display the attention degree to a user. The attention degree evaluating component 140 accepts a user's operation on the evaluation result from the user terminal 20. For example, the attention degree evaluating component 140 may add an expression to be evaluated as a new keyword according to the user's operation.

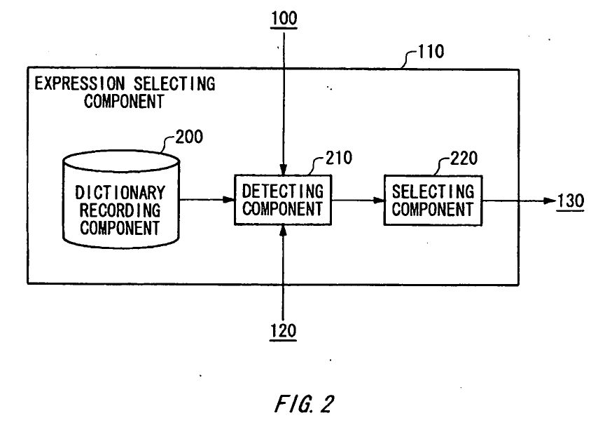

FIG. 2 shows a functional configuration of the expression selecting component 110. The expression selecting component 110 has a dictionary recording component 200, a detecting component 210, and a selecting component 220. The dictionary recording component 200 records a plurality of expressions in advance. These expressions are common names, idiomatic expressions, and other well-known expressions broadly known to general users. The detecting component 210 detects, for each of the keywords, unregistered expressions not recorded in the dictionary recording component 200 among expressions included in a text including that keyword. A text including a predetermined keyword may be retrieved by the search engine 120. That is to say, the detecting component 210 may retrieve, for each of the keywords, a text including that keyword and detect unregistered expressions in the retrieved text.

The selecting component 220 selects, for at least two of the keywords, one or more unregistered expressions that have been detected from texts including any of the at least two keywords. The number of keywords may be predetermined by a user. That is to say, for example, the selecting component 220 may select a unregistered expression detected in texts including any of a predetermined number of keywords. The predetermined number may be two or more. However, these keywords may not be predetermined. That is to say, the selecting component 220 may select, for any two of the input keywords, an unregistered expression detected in texts including any of the keywords.

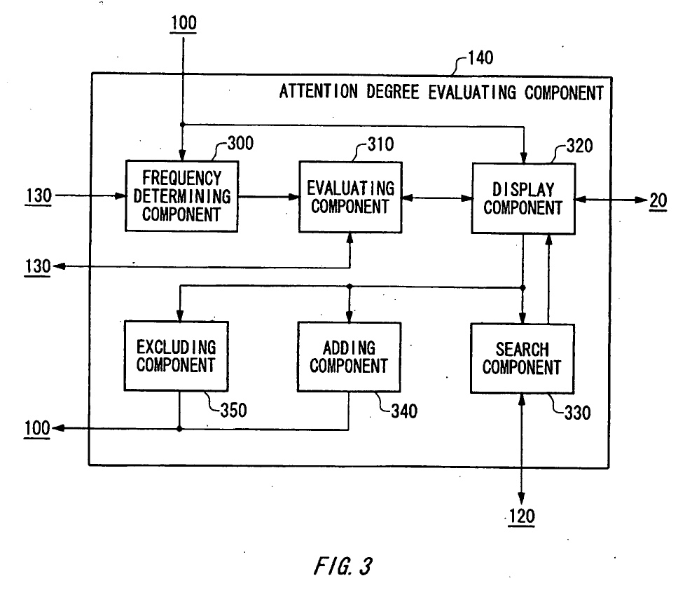

FIG. 3 shows a functional configuration of the attention degree evaluating component 140. The attention degree evaluating component 140 has a frequency determining component 300, an evaluating component 310, a display component 320, a search component 330, an adding component 340, and an excluding component 350. The frequency determining component 300 receives a plurality of keywords from the input component 100 and acquires an expression to be evaluated from the expression recording component 130. Then, the frequency determining component 300 determines, for each of the keywords, use frequencies of the expressions to be evaluated in a text including that keyword. The use frequency may be the total number of times an expression to be evaluated is used in that text. Alternatively, the use frequency may be an index value made by dividing the total number of times by the amount of texts in which an expression to be evaluated is used, or may be an index value made by dividing that total number of times by the amount of texts that have been searched on the network 15.

The evaluating component 310 evaluates attention degrees of expressions to be evaluated based on the respective use frequencies determined for each keyword. The evaluation results are output to the display component 320. The evaluation results may be recorded in the expression recording component 130 in association with the respective expressions to be evaluated. The display component 320 outputs the expressions to be evaluated to the user terminal 20 in association with the attention degrees, and makes the user terminal 20 display those to a user. Specifically, the display component 320 may display the expressions to be evaluated in association with the attention degrees evaluated by the evaluating component 310 in a selectable manner. The selectable display may be implemented by a symbol arranged next to an expression to be evaluated, which can be clicked by a mouse. The selectable display may have a plurality of symbols according to operations performed by clicking of a mouse button. The display component 320 may further display the input keyword in association with the expression to be evaluated, which has been evaluated according to the keyword. This keyword may also be displayed in a selectable manner.

The search component 330 retrieves a text including an expression to be evaluated from a plurality of texts and outputs the retrieved text to the display component 320, in response to selection of the expression to be evaluated by a user. The search result may be displayed to the user by the display component 320. The adding component 340 may inform, in response to selection of an expression to be evaluated by the user, the input component 100 of the expression to be evaluated in order to add the expression as a new keyword. The excluding component 350 may exclude, in response to selection of a keyword by the user, the keyword from a group of keywords for evaluating attention degrees of other expressions to be evaluated by means of the evaluating component 310.

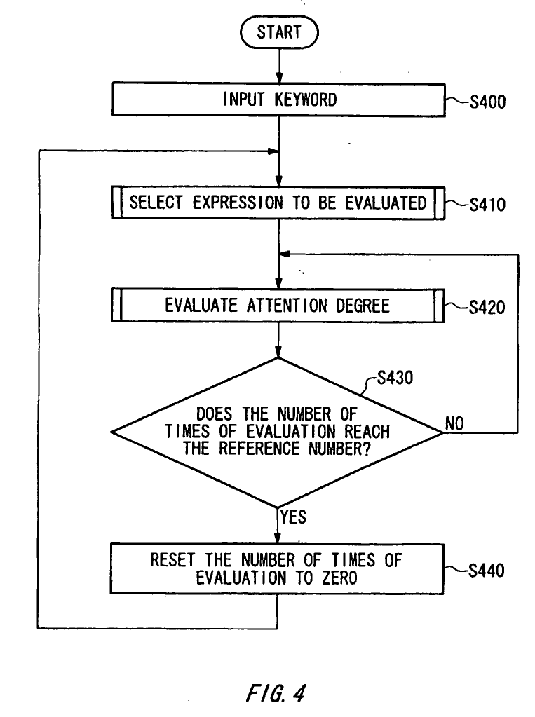

FIG. 4 shows a flow of a process by which the search apparatus 10 evaluates attention degrees of expressions. The input component 100 inputs a plurality of keywords from the user terminal 20 (S400). The input component 100 may input a plurality of keywords for each field in which the user is interested. In this case, the input component 100 inputs a plurality of keywords for each expression to be evaluated. Keywords for evaluating a certain expression to be evaluated may be different from keywords for evaluating another expression to be evaluated, or at least one of the keywords may be common. As an example, keywords for a specific field are A, B and C, and keywords for another specific field are B, C and D, where B and C are common keywords.

Next, the expression selecting component 110 selects an expression to be evaluated from unregistered expressions and records the selected expression in the expression recording component 130 (S410). Then, the attention degree evaluating component 140 sequentially evaluates the attention degree of the expression to be evaluated (S420). Until the number of times of evaluation for the attention degree reaches a predetermined reference number (S430: NO), the attention degree evaluating component 140 repeats the process of S420. The reference number is a predetermined number equal to or greater than two. On condition that the number of times of evaluation has reached the reference number (S430: YES), the attention degree evaluating component 140 resets the number of times of evaluation to zero (S440). In this case, since the expression to be evaluated may be changed, information on the attention degree already evaluated for each of the expressions to be evaluated may be discarded. The search apparatus 10 returns the process to S410.

As described above, according to the process shown in FIG. 4, the detecting component 210 detects unregistered expressions at a plurality of different points in time, and the selecting component 220 updates the recorded expressions to be evaluated whenever a unregistered expression is detected. The frequency determining component 300 determines use frequencies of expressions to be evaluated more frequently than the frequency with which the detecting component 210 detects unregistered expressions. Here, the detection of unregistered expressions may need a relatively long processing time. The reason is that a process for analyzing a text to decompose it into words and a process for comparing the processing results with a dictionary need a lot of time. On the other hand, the evaluation of attention degrees does not need a long processing time. That is to say, according to the process of FIG. 4, in the case where the type of expression to be used does not change so much and only the frequency changes, it is possible to effectively evaluate attention degrees by following the change.

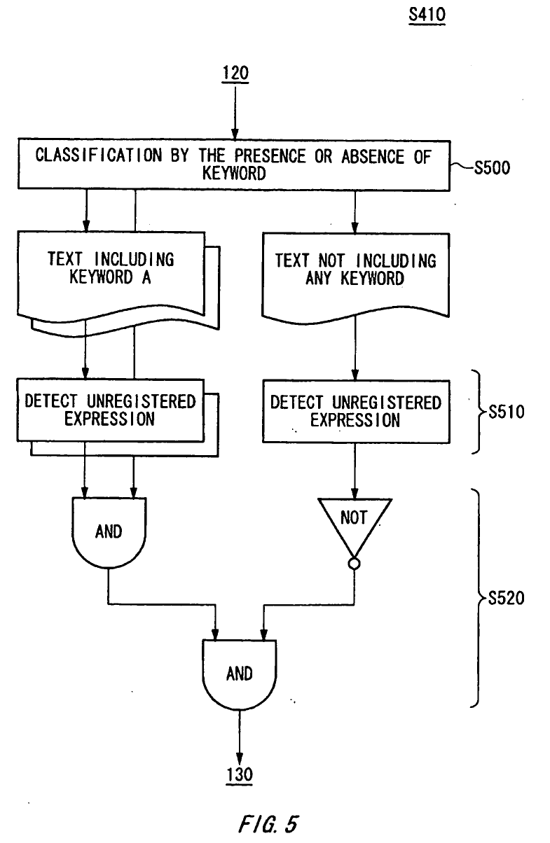

FIG. 5 conceptually shows the process in S410. The detecting component 210 classifies a plurality of texts based on whether a keyword is included or not (S500). A text including a keyword A and a text including a keyword B are illustrated at a left side. A text not including any keyword is illustrated at a right side. The detecting component 210 detects unregistered expressions from each text (S510), if any. The detecting component 210 may detect unregistered expressions from a text including a keyword, and further detect unregistered expressions from a text not including any keyword.

The selecting component 220 selects, for at least two of the keywords (here, for the keywords A and B), one or more unregistered expressions that have been detected from texts including any of the at least two keywords (S520). That is to say, a product set of unregistered expressions detected from the text including the keyword A and from the text including the keyword B is selected. FIG. 5 shows this selection process by means of an AND gate.

It is preferable that the selecting component 220 performs selection by excluding an unregistered expression detected from a text not including any keyword from the selected unregistered expressions (S520). That is to say, selected is a product set of a product set of unregistered expressions detected from the text including the keyword A and from the text including the keyword B and a complement set of unregistered expressions detected from the text not including any keyword. FIG. 5 shows this selection process as a combination of a NOT gate and an AND gate. The selected unregistered expression is recorded in the expression recording component 130 as an expression to be evaluated.

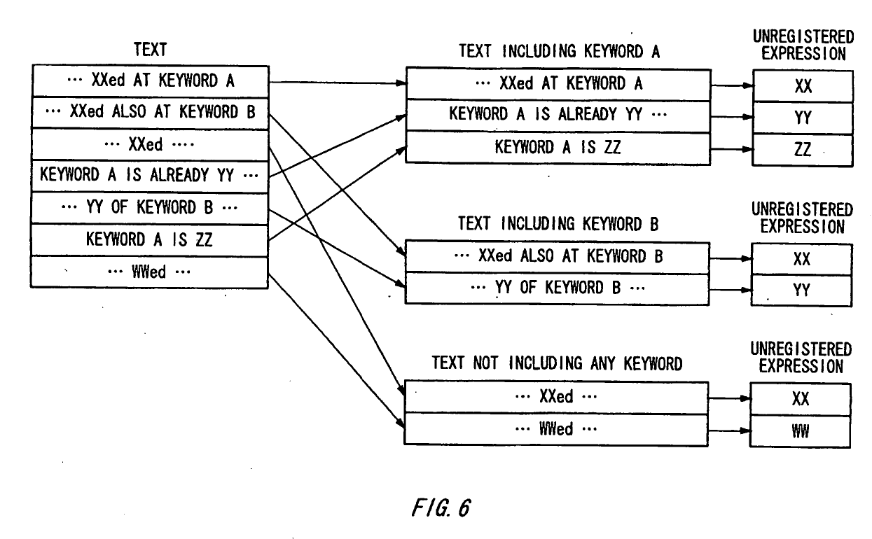

FIG. 6 shows a first part of a specific example of the process in S410. A plurality of texts are illustrated at the leftmost side. A text may be a text file, or may be a single line in a text file. A line may be a sentence delimited by a period, or may be a sentence delimited by a tag indicating a line feed in a HTML document. In this example, character data such as “. . . XXed at a keyword A” is detected as a text.

The detecting component 210 detects, for each of the keywords, unregistered expressions among expressions included in a text including that keyword. That is to say, the detecting component 210 may detect unregistered expressions among expressions included a line including the keyword, or may detect unregistered expressions among expressions included in a text file including the keyword. As a result, for the keyword A, XX, YY and ZZ are detected as unregistered expressions. For the keyword B, XX and YY are detected unregistered expressions. On the other hand, XX and WW are detected from a text not including any keyword as unregistered expressions.

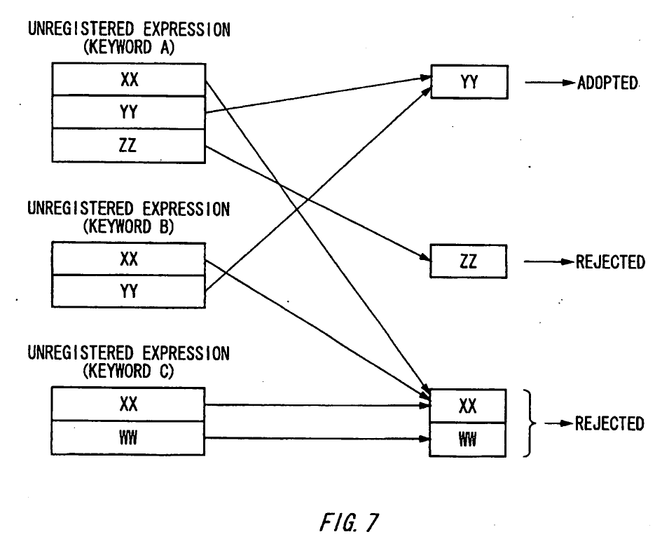

FIG. 7 shows a second part of the specific example of the process in S410. The selecting component 220 selects, for at least two of the keywords, one or more unregistered expressions that have been detected from a text (e.g., a line or a text file) including any of the at least two keywords. Since the unregistered expression YY has been detected for both the keywords A and B, the expression “YY” is selected as an expression to be evaluated.

On the other hand, since the expression “ZZ” has been detected from only a text including the keyword A, the expression “ZZ” is not adopted as an expression to be evaluated. Although the expression “XX” has been detected for each of the keyword, the expression “XX” is not adopted as an expression to be evaluated because it has also been detected from a text not including any keyword. Since the expression “WW” has not been detected for any keyword, the expression “WW” is not adopted as an expression to be evaluated.

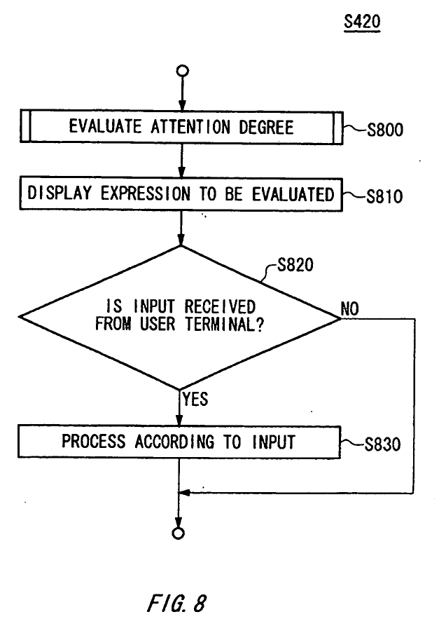

FIG. 8 shows the details of the process in S420. The frequency determining component 300 and the evaluating component 310 evaluate an attention degree for an expression to be evaluated (S800). The display component 320 causes the user terminal 20 to display an expression to be evaluated in association with an attention degree (S810). When the display component 320 receives a user's selection operation or other inputs from the user terminal 20 (S820: YES), the search component 330, the adding component 340, and the excluding component 350 perform the respective processes according to the input contents (S830).

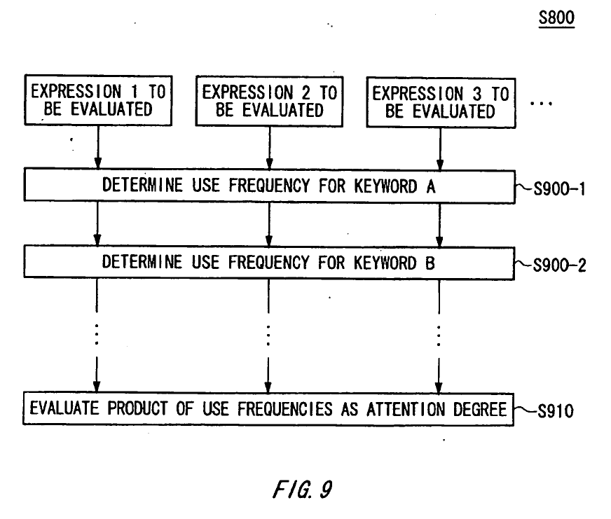

FIG. 9 conceptually shows the process in S800. It is now assumed that the keywords A and B are input. It is further assumed that an expression 1 to be evaluated, an expression 2 to be evaluated, and an expression 3 to be evaluated are selected. The frequency determining component 300 first determines a use frequency of each of the expressions 1 to 3 to be evaluated in texts including the keyword A (S900-1). Next, the frequency determining component 300 determines a use frequency of each of the expressions 1 to 3 to be evaluated in texts including the keyword B (S900-2). Texts including each keyword can be retrieved by a normal search process. The use frequency is obtained based on the usage count of an expression used in texts.

Then, the evaluating component 310 evaluates an attention degree based on each use frequency for each keyword (S910). For example, the evaluating component 310 may evaluate a product of use frequencies determined for a plurality of key words as an attention degree. Thus, an expression associated with all of the input keywords can be evaluated as an expression with a high attention degree, as compared with an expression associated with only one of the input keywords. Alternatively, the evaluating component 310 may evaluate an attention degree higher in the case where the difference between the use frequencies determined for the respective keywords is smaller, than in the case where the difference between the use frequencies is larger. With such a method, a product of use frequencies may not be identical with an attention degree.

Furthermore, the evaluating component 310 may evaluate an attention degree based on an inter-word distance in a text between each keyword and an expression to be evaluated. Here, an inter-word distance between two expressions means a logical distance between a position at which one word appears in the text and a position at which another word appears in the text. For example, an inter-word distance between words is shorter in the case where these two words appear on the same line (one sentence delimited by a period), than in the case where these words appear on different lines in the same sentence. Similarly, an inter-word distance between words is shorter in the case where these two words appear in the same chapter or section, than in the case where these words appear in different chapters or sections.

Specifically, the evaluating component 310 first computes a weighted use frequency by multiplying a weight based on an inter-word distance between each keyword and an expression to be evaluated by a use frequency determined for that keyword. Then, the evaluating component 310 may evaluate an attention degree based on the weighted use frequency computed for each keyword. That is to say, in the case where a keyword is found in a heading or a title of a text, a higher weight may by multiplied by a use frequency of an expression to be evaluated used in the text, as compared with the case where a keyword is included in a normal sentence in a text. Thus, it is possible to more appropriately evaluate an attention degree of an expression to be evaluated.

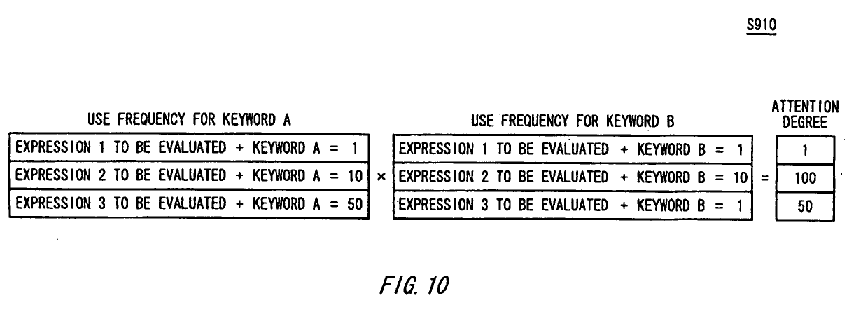

FIG. 10 shows a specific example of the process in S910. The expression 1 to be evaluated is once used in a text including the keyword A and the expression 1 to be evaluated is once used in a text including the keyword B. For this reason, the evaluating component 310 evaluates that an attention degree of the expression 1 to be evaluated is one by 1*1. On the other hand, the expression 2 to be evaluated is ten times used in the text including the keyword A and the expression 2 to be evaluated is ten times used in the text including the keyword B. For this reason, the evaluating component 310 evaluates that an attention degree of the expression 2 to be evaluated is 100 by 10*10.

The expression 3 to be evaluated is 50 times used in the text including the keyword A and the expression 3 to be evaluated is once used in the text including the keyword B. For this reason, the evaluating component 310 evaluates that an attention degree of the expression 3 to be evaluated is 50 by 50*1.

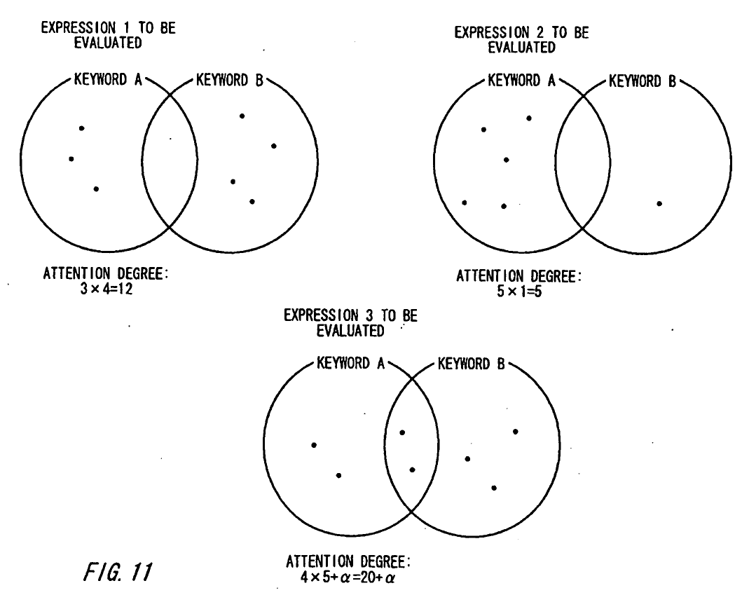

FIG. 11 conceptually shows a computation method for an attention degree. If an expression to be evaluated is frequently used even in a text including any keyword, the attention degree is high. On the other hand, although an expression is frequently used in a text including a certain keyword, an attention degree of the expression is low if the expression is not much used in texts including other keywords. Specifically, the expression 1 to be evaluated in FIG. 11 appears at seven places in total and the expression 2 to be evaluated appears at six places in total. Thus, the difference is only one place. However, an attention degree of the expression 1 to be evaluated is 12, which is obtained by multiplying three that is the number of times appearing in the text including the keyword A by four that is the number of times appearing in the text including the keyword B. On the other hand, an attention degree of the expression 2 to be evaluated is five, which is obtained by multiplying five that is the number of times appearing in the text including the keyword A by one that is the number of times appearing in the text including the keyword B. In this manner, since an attention degree is obtained by a product of use frequencies, an attention degree of an expression associated with all of the keywords can be evaluated higher than an expression associated with only one of the keywords.

In the case where a certain expression to be evaluated is detected from a text including all of the keywords, the evaluating component 310 may evaluate an attention degree of the expression to be evaluated even higher. In FIG. 11, such a text corresponds to a region of a product set of the keyword A and the keyword B. It is considered that a text corresponding to this region is strongly associated with any keyword and thus an interest of a user is high. In the example of FIG. 11, the number of times of a certain expression to be evaluated (e.g., the expression 3 to be evaluated) appearing in a text including the keyword A is four. On the other hand, the number of times of the expression 3 to be evaluated appearing in a text including the keyword B is five. Therefore, the evaluating component 310 first computes 20 that is a product of four and five as an attention degree of the expression 3 to be evaluated. Furthermore, since the expression 3 to be evaluated is detected from a text region including both of the keywords A and B, the evaluating component 310 evaluates the attention degree of the expression 3 to be evaluated even higher. For example, the evaluating component 310 may compute a value obtained by adding a predetermined positive number a to 20 that is a product of the numbers of times appearing in the text as an attention degree of the expression 3 to be evaluated.

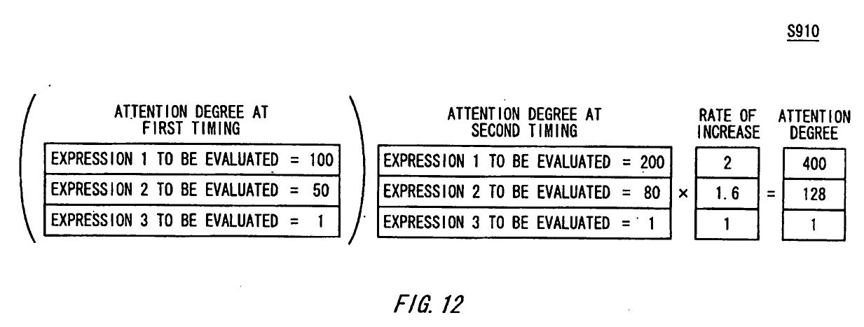

FIG. 12 shows another example of the process in S910. The evaluating component 310 may evaluate an attention degree according to a process shown in FIG. 12 in place of the process shown in FIG. 10. According to a process shown in FIG. 12, it is possible to evaluate an attention degree higher in response to a rate of increase of use frequency of an expression. Specifically, an attention degree evaluated at a first point in time or first timing is shown on the extreme left of the drawing. This attention degree is obtained based on the use frequency determined by the frequency determining component 300 at the first timing.

An attention degree evaluated at a second point in time or second timing is shown at the center of the drawing. This attention degree is obtained based on the use frequency determined by the frequency determining component 300 at the second timing. The evaluating component 310 obtains a rate of increase of the attention degree obtained at the second timing to the attention degree obtained at the first timing. As shown in the drawing, the rate of increase is respectively 2, 1.6 and 1 for the expression 1 to be evaluated, the expression 2 to be evaluated, and the expression 3 to be evaluated, respectively.

The evaluating component 310 evaluates an attention degree of each expression to be evaluated by multiplying the obtained rate of increase by the attention degree obtained at the second timing. That is to say, an attention degree of the expression 1 to be evaluated is evaluated as 400 by multiplying two by 200, an attention degree of the expression 2 to be evaluated is evaluated as 128 by multiplying 1.6 by 80, and an attention degree of the expression 3 to be evaluated is evaluated as one by multiplying one by one. In this manner, the evaluating component evaluates an attention degree of an expression to be evaluated higher in the case where a rate of increase of use frequency of the expression higher, than in the case where the rate of increase is lower. In this way, it is possible to evaluate an expression that has become frequently used in a specific field even higher.

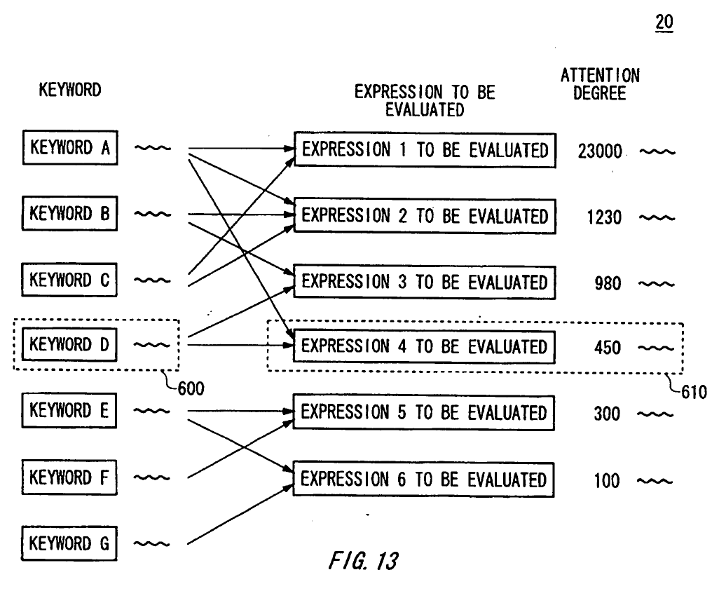

FIG. 13 shows an exemplary screen displayed on the user terminal 20 by the display component 320. The display component 320 displays, in a selectable manner, each of the expressions to be evaluated in association with the attention degree evaluated by the evaluating component 310. For example, the selectable display may be implemented by a symbol arranged next to an expression to be evaluated, which can be clicked by a mouse. For example, a symbol for searching texts using an expression to be evaluated as a key may be displayed next to the expression to be evaluated. This will be described below in detail.

Here, it is preferable that the display component 320 displays a plurality of expressions to be evaluated side-by-side from an upper part of the screen in order of attention degrees evaluated by the evaluating component 310 for the respective expressions to facilitate selection by a user. In this case, when an attention degree of a certain expression to be evaluated is further evaluated, the display component 320 may preferentially display the expression to be evaluated and other expressions already evaluated in order of the attention degrees to facilitate selection by a user. In this way, a user can immediately recognize an expression with a high attention degree.

Additionally, the display component 320 displays each input keyword in association with an expression to be evaluated for which an attention degree is evaluated by means of that keyword. That is to say, the present example shows that the expression 1 to be evaluated, the expression 2 to be evaluated, and the expression 4 to be evaluated are evaluated by means of the keyword A. Here, in the case where a certain keyword corresponds to a lot of expressions to be evaluated with high use frequencies, it is more likely that the keyword is a general expression commonly used in various fields. For this reason, with such a keyword, an attention degree of an expression of a specific field may not be appropriately evaluated. Therefore, it is preferable that the display component 320 preferentially displays each of the input keywords in order of the number of expressions to be evaluated each having an attention degree evaluated by that keyword, which is equal to or greater than a predetermined reference, to facilitate selection by a user. A keyword selected by the user is excluded by the excluding component 350 from the keywords for evaluating attention degrees of other expressions to be evaluated. In this way, the user can increase accuracy of the attention degree evaluation in the following processes.

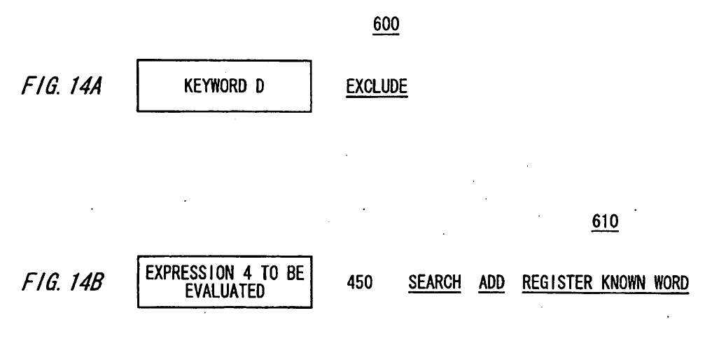

FIGS. 14A and 14B show details of display contents in display are as 600 and 610, respectively. As shown in FIG. 14A, the display component 320 displays a symbol, which can be clicked by a mouse, next to a keyword in the display area 600. In FIG. 14A, this symbol is a hyperlink by a character string “EXCLUDE”. The excluding component 350 determines that a symbol “EXCLUDE” is clicked and thus a keyword next to the symbol is selected by the user. Then, the excluding component 350 excludes the keyword selected by the user from the keywords for evaluating attention degrees of other expressions to be evaluated by means of the evaluating component 310.

As shown in FIG. 14B, the display component 320 displays three symbols, each of which can be clicked by a mouse, next to an expression to be evaluated in the display area 610. In FIG. 14B, these symbols are hyperlinks by character strings “SEARCH”, “ADD”, and “REGISTER KNOWN WORD”. The search component 330 determines that the symbol “SEARCH” is clicked and thus an expression to be evaluated next to the symbol is selected by the user. In that case, the search component 330 may search the network 15 by means of the expression to be evaluated and a plurality of keywords with which the expression has been evaluated. In this way, a text including both the expression to be evaluated and the keywords is retrieved.

The adding component 340 determines that the symbol “ADD” is clicked and thus an expression to be evaluated next to the symbol is selected by a user. It is assumed that the expression to be evaluated is a first expression to be evaluated. Then, the adding component 340 adds the first expression to be evaluated as a keyword for evaluating a second expression to be evaluated next when the first expression to be evaluated is selected by the user. For example, the adding component 340 may inform the input component 100 that the first expression to be evaluated is used as an expression input as a keyword.

The evaluating component 310 determines that the symbol “REGISTER KNOWN WORD” is clicked and thus an expression to be evaluated next to the symbol is selected by the user. Then, the evaluating component 310 may inform, when an expression to be evaluated is selected by the user, the expression recording component 130 that the expression to be evaluated is registered as a known word.

As described above, according to the display examples shown in FIGS. 13, 14A, and 14B, it is possible to display expressions to be evaluated each having a high attention degree to a user in an easily understood manner to make a user effectively utilize the evaluation results. Keywords for evaluating a lot of expressions to be evaluated each having a high use frequency are also displayed in such a way that they can be easily selected as it is more likely that the keywords are general terms. Thus, it is possible to prompt a user to modify the evaluation method so that accuracy of the evaluation is increased every time the evaluation is performed.

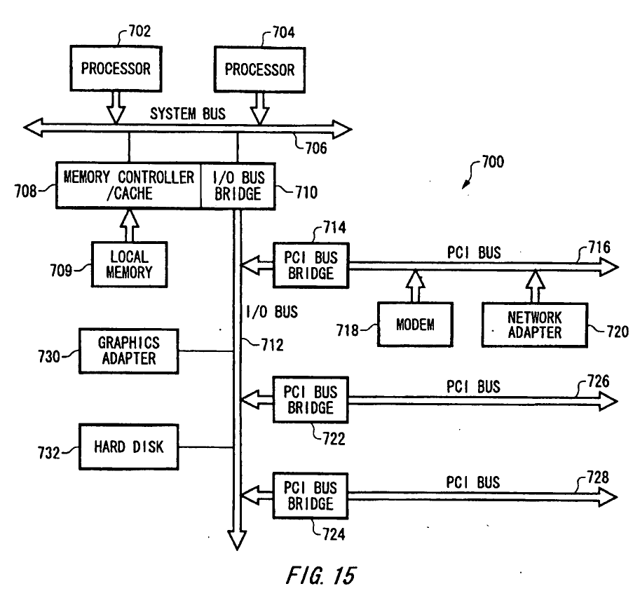

FIG. 15 shows an exemplary hardware configuration of the information processing apparatus 700 functioning as the search apparatus 10. The information processing apparatus 700 may be a system incorporating a symmetric multiprocessor (SMP). Specifically, the information processing apparatus 700 has a plurality of processors (processors 702 and 704). The processors 702 and 704 are connected to each other via a system bus 706. Alternatively, the information processing apparatus 700 may have a single processor.

The system bus 706 is further connected to a memory controller/cache 708. The memory controller/cache 708 provides an interface for a local memory 709. An I/O bus bridge 710 is connected to the system bus 706. The I/O bus bridge 710 provides an interface for an I/O bus 712. The memory controller/cache 708 and the I/O bus bridge 710 may be integrated in a single LSI.

A PCI (Peripheral Component Interconnect) bus bridge 714 is connected to the I/O bus 712. The I/O bus 712 provides an interface for a PCI bus 716. In a typical PCI bus implementation, four PCI expansion slots are provided and an add-in connector is also provided.

A communication link for the user terminal 20 is provided via a modem 718 and a network adapter 720. The modem 718 and the network adapter 720 are connected to the PCI bus 716 via an add-in board. PCI bridges 722 and 224 provide interfaces for additional PCI buses 226 and 228. Additional modem and network adapter may be connected to these PCI buses. Therefore, the information processing apparatus 700 can be connected to a plurality of other information processing apparatuses (e.g., the user terminal 20). A graphics adapter 730 and a hard disk 732 are further connected to the I/O bus 712.

The hardware configuration shown as the above is merely an example. Thus, it is appreciated that those skilled in the art can add various modifications to this configuration. For example, the information processing apparatus 700 may have another peripheral device, e.g., an optical drive. The above configuration does not limit hardware realizing the present invention.

While the present invention has been described by way of the preferred embodiment, it should be understood that those skilled in the art can make many changes and substitutions without departing from the spirit and the scope of the present invention which is defined only by the appended claims.

What is claimed is:

1. A search apparatus for searching expressions from a plurality of texts, comprising:
an expression recording component recording expressions to be evaluated;
an input component for a plurality of keywords;
a frequency determining component determining use frequencies of the expressions to be evaluated; and
an evaluating component evaluating an attention degree of the expressions to be evaluated based at least in part on the use frequencies.

2. The search apparatus as claimed in claim 1, wherein:
the expressions to be evaluated are predetermined;
the expression recording component records the predetermined expressions in advance; and
the frequency determining component determines, for each of the keywords, use frequencies of the expressions to be evaluated in a text including at least one of the plurality of keywords.

3. The search apparatus as claimed in claim 2, wherein the evaluating component evaluates the attention degree higher in the case where the difference between the use frequencies determined for the respective keywords is smaller, than in the case where that difference is larger.

4. The search apparatus as claimed in claim 3, wherein the evaluating component evaluates a product of the use frequencies determined for the respective keywords as the attention degree.

5. The search apparatus as claimed in claim 2, wherein the evaluating component computes a weighted use frequency by multiplying a weight based on an inter-word distance between each keyword and the expression to be evaluated by the use frequency determined for that keyword, and evaluates the attention degree based on the weighted use frequency computed for each keyword.

6. The search apparatus as claimed in claim 2, further comprising:
a display component displaying, in a selectable manner, the expression to be evaluated in association with the attention degree evaluated by the evaluating component; and
a search component retrieving and outputting a text including the expression to be evaluated from the plurality of texts when the expression to be evaluated is selected by a user.

7. The search apparatus as claimed in claim 6, wherein the search component retrieves and displays a text including the expression to be evaluated and the plurality of keywords when the expression to be evaluated is selected by the user.

8. The search apparatus as claimed in claim 2, wherein
the expression recording component records a plurality of expressions to be evaluated,
the evaluating component evaluates an attention degree of a first one of the expressions to be evaluated, and
the search apparatus further comprises:
a display component displaying, in a selectable manner, the first expression to be evaluated in association with the attention degree evaluated by the evaluating component; and
an adding component adding the first expression to be evaluated as a keyword for evaluating a second expression to be evaluated when the first expression to be evaluated is selected by a user.

9. The search apparatus as claimed in claim 8, wherein the display component preferentially displays the first expression to be evaluated and the other expressions already evaluated in order of the attention degrees to facilitate selection by the user.

10. The search apparatus as claimed in claim 2, wherein
the expression recording component records a plurality of expressions to be evaluated,
the input component inputs, for each expression to be evaluated, a plurality of keywords, at least a part of which are common to keywords for evaluating other expressions to be evaluated,
the evaluating component sequentially evaluates the plurality of expressions to be evaluated based on the input keywords, and
the search apparatus further comprises:
a display component preferentially displaying each of the input keywords in order of the number of expressions to be evaluated each having an attention degree evaluated by that keyword, which is equal to or greater than a predetermined reference, to facilitate selection by a user; and
an excluding component excluding a keyword selected by the user from the keywords for evaluating attention degrees of other expressions to be evaluated by means of the evaluating component.

11. The search apparatus as claimed in claim 2, wherein
the frequency determining component determines, for at least one of the keywords, a use frequency with which the expression to be evaluated is used in a text including that keyword at a plurality of different points in time, and
the evaluating component evaluates the attention degree higher in the case where a rate of increase of the use frequency from the one determined for that keyword at a first point in time to the one determined for that keyword at a second point in time after the first point in time is higher, than in the case where the rate of increase is lower.

12. The search apparatus as claimed in claim 2, further comprising:
a dictionary recording component recording a plurality of expressions in advance;
a detecting component detecting, for each of the keywords, unregistered expressions not recorded in the dictionary recording component among expressions included in a text including that keyword; and
a selecting component selecting, for at least two of the keywords, one or more unregistered expressions that have been detected from texts including any of the at least two keywords,
wherein the expression recording component records the unregistered expression selected by the selecting component as the expression to be evaluated.

13. The search apparatus as claimed in claim 12, wherein
the detecting component detects an unregistered expression at a plurality of different points in time,
the expression recording component updates the recorded expressions to be evaluated whenever an unregistered expression is detected, and
the frequency determining component determines the use frequencies of the expressions to be evaluated more frequently than the frequency with which the detecting component detects an unregistered expression.

14. A search apparatus for searching expressions from a plurality of texts, comprising:
a dictionary recording component recording a plurality of expressions in advance;
an input component receiving a plurality of keywords from a user;
a detecting component detecting, for each of the keywords, unregistered expressions not recorded in the dictionary recording component among the expressions included in a text including that keyword; and
a selecting component selecting, for at least two of the keywords, one or more unregistered expressions that have been detected from texts including any of the at least two keywords.

15. The search apparatus as claimed in claim 14, wherein
the detecting component detects, for each of the keywords, unregistered expressions among the expressions included in a line including that keyword, and
the selecting component selects the unregistered expressions that have been detected from lines including any of the at least two keywords.

16. The search apparatus as claimed in claim 14, wherein
the detecting component detects, for each of the keywords, unregistered expression among the expressions included in a text file including that keyword, and
the selecting component selects the unregistered expressions that have been detected from text files including any of the at least two keywords.

17. The search apparatus as claimed in claim 14, wherein
the detecting component further detects unregistered expressions from a text not including any of the keywords, and
the selecting component excludes the unregistered expressions detected from the text not including any of the keywords from the unregistered expressions detected for the at least two keywords.

18. The search apparatus as claimed in claim 14, wherein the selecting component selects, for two of the keywords, one or more unregistered expressions that have been detected from texts including the two keywords.

19. A search method for searching expressions from a plurality of texts, comprising the steps of:
recording predetermined expressions included in at least one text as expressions to be evaluated for which attention degrees are evaluated;
receiving a plurality of keywords;
determining, for one or more of the keywords, use frequencies of the expressions to be evaluated in a text including that keyword; and
evaluating the attention degrees of the expressions to be evaluated based on the respective use frequencies determined for the one or more keywords.

20. The search method of claim 19, wherein the predetermined expressions are recorded in advance.

21. A search method for searching expressions from a plurality of texts, comprising:
receiving a plurality of keywords from a user;
detecting, for one or more of the keywords, unregistered expressions that are different from expressions registered in a dictionary among expressions included in a text including that keyword; and
selecting one or more unregistered expressions that have been detected from texts including any of the one or more keywords.

22. The method of claim 21, further comprising outputting the selected one or more unregistered expressions.

23. The method of claim 21, further comprising selecting, for at least two keywords, one or more unregistered expressions that have been detected from texts including any of the at least two keywords.

24. A computer program product, comprising:
(a) a program for causing an information processing apparatus to function as a search apparatus for searching expressions from a plurality of texts, the program causing the information processing apparatus to function as:
an expression recording component recording in advance predetermined expressions included in at least one text as expressions to be evaluated for which attention degrees are evaluated;
an input component inputting a plurality of keywords;
a frequency determining component determining, for each of the keywords, use frequencies of the expressions to be evaluated in a text including that keyword; and
an evaluating component evaluating the attention degrees of the expressions to be evaluated based on the respective use frequencies determined for each of the keywords;
(b) a computer readable media bearing the program.

25. A computer program product, comprising:
(a) a program for causing an information processing apparatus to function as a search apparatus for searching expressions from a plurality of texts, the program causing the information processing apparatus to function as:
a dictionary recording component recording a plurality of expressions in advance;
an input component receiving a plurality of keywords from a user;
a detecting component detecting, for each of the keywords, unregistered expressions not recorded in the dictionary recording section among the expressions included in a text including that keyword; and
a selecting component selecting and outputting, for at least two of the keywords, one or more unregistered expressions that have been detected from texts including any of the at least two keywords;
(b) a computer readable media bearing the program.

26. A method of providing a search services to a customer over a network, comprising:
receiving one or more keywords; and
calculating an attention degree for each of the keywords.

27. The method of claim 26, further comprising:
recording, in advance, predetermined expressions included in at least one text as expressions to be evaluated; and
determining for each of the keywords, use frequencies of the predetermined expressions in a text including that keyword.
